(19) United States
(12) Patent Application Publication
(10) Pub. No.: US 2025/0316940 A1
(43) Pub. Date: Oct. 9, 2025

(54) ADAPTER FOR OCP MODULE

(71) Applicant: HEWLETT PACKARD ENTERPRISE DEVELOPMENT LP, Spring, TX (US)

(72) Inventors: Peng Chianghsieh, Taoyuan City (TW); Yu Han Lin, Taoyuan City (TW); Jui Lin Chen, Taipei City (TW)

(21) Appl. No.: 18/628,888

(22) Filed: Apr. 8, 2024

(51) Int. Cl. H01R 31/06; H01R 12/72; H01R 13/627; H01R 13/6581

(52) U.S. Cl. CPC H01R 31/065; H01R 12/722; H01R 13/6271; H01R 13/6581; H01R 2201/06

(57) ABSTRACT

An adapter, a system and a method. The adapter comprising a frame that comprises an inner engagement features configured to engage with an OCP module received in the interior volume and to attach the OCP adapter to the OCP module and an outer engagement features configured to engage with engagement features of a bay of the EDSFF drive cage as the OCP adapter is inserted into the bay, and a latching mechanism connected to the frame and configured to latch into a latching feature of the EDSFF cage in an installed state of the OCP adapter in the bay.

### INTRODUCTION

Many servers are configured to receive various pluggable modules, such as hot-swappable storage drives or Open Compute Project (OCP) modules. Pluggable modules may be installed in corresponding bays, which are receptacles configured to removably receive the pluggable modules from an exterior of the server chassis (e.g., without needing to open the chassis).

For example, storage drives may be received in drive bays formed by a drive cage, which comprises a box-like support structure which defines multiple drive bays. The drive cage may form part of the chassis of the server and is often part of the front panel thereof. The drive cage may include, for each drive bay, a set of engagement features (e.g., rails), which engage with the drive as the drive is inserted into the bay. The engagement features guide the drive into the correct installation position and physically support the drive when installed. Each drive bay is also provided with a corresponding electrical connector which is positioned in the bay such that, when the drive is inserted into the bay, the engagement features guide the drive into blind mating with the electrical connector of the bay. The electrical connectors are often attached to a backplane, which comprises a printed circuit board assembly (PCA) which is electrically connected to a primary system board of the server such that the installed drives are electrically connected to the primary system board via the backplane.

As another example, OCP modules, such as an OCP network interface card (NIC), are generally installed in corresponding OCP bays located at the rear of the server. These OCP modules may be electrically connected to the system board via connectors which are attached to a rear edge of the system board. Rails attached to the chassis may guide the OCP modules into their installed position.

### BRIEF DESCRIPTION OF THE DRAWINGS

The present disclosure can be understood from the following detailed description, either alone or together with the accompanying drawings. The drawings are included to provide a further understanding of the present disclosure and are incorporated in and constitute a part of this specification. The drawings illustrate one or more examples of the present teachings and together with the description explain certain principles and operation. In the drawings:

FIG. 1 is a block diagram illustrating an example of an OCP module adapter, an example OCP module/adapter assembly comprising the OCP module adapter and an OCP module, and an example system comprising the assembly and an EDSFF drive cage.

FIG. 2 is an exploded view of another example system comprising an example EDSFF cage and another example OCP module/adapter assembly comprising an example OCP module and an example OCP adapter.

FIG. 3A is a perspective view of the OCP module adapter of FIG. 2 with a rear-side latching mechanism.

FIG. 3B is a perspective view of the OCP module/adapter assembly of FIG. 2.

FIG. 4A is a front plan view of the EDSFF drive cage of FIG. 2.

FIG. 4B is a perspective view of the example system of FIG. 2 with one of the OCP module/adapter assemblies in an installed position and another one of the OCP module/adapter assemblies in an uninstalled position.

FIG. 4C is cross-section of the system of FIG. 2 taken along plane 4C shown in FIG. 4B.

FIG. 5 is a perspective view of the system of FIG. 3 with two of the OCP module/adapter assemblies in installed positions.

FIG. 6A is a perspective view of another example OCP module adapter with a front-side latching mechanism.

FIG. 6B is a perspective view of another OCP module/adapter assembly comprising an OCP module installed in the OCP module adapter of FIG. 6A with a front-side latching mechanism.

FIG. 7 is a perspective view of an example system comprising an example drive cage and one of the OCP module adapter assemblies of FIG. 6B in an installed position.

FIG. 8 is a block diagram illustrating an example system with an OCP module installed using OCP module adapter.

FIG. 9 is a perspective view of an example system configured to receive OCP modules using OCP adapter.

The drawings are included to provide a further understanding of the present disclosure and are incorporated in and constitute a part of this specification. The drawings illustrate one or more examples of the present teachings and together with the description explain certain principles and operations. In some occasions, details that are not necessary for an understanding of an instance of this disclosure or that render other details difficult to perceive may have been omitted.

### DETAILED DESCRIPTION

Although OCP modules are usually connected to a system board via OCP connectors which are straddle-mounted to the rear edge of the system board to receive the OCP modules inserted through the rear panel. Under some circumstances, it may be desired to have an OCP module located at the front panel of the server, as noted above. However, positioning the OCP modules at the front panel of a server can be challenging. Specifically, it may not be feasible to provide OCP connectors at a front edge of the system board to receive OCP modules inserted through the front panel because a distance between the front panel and the front edge of the system board may be too great. In addition, there may also be components, such as fans, which sit between the front panel and the system board, and these other components might block OCP modules inserted through the font panel and prevent them from reaching the connectors.

In addition, in existing systems, the front panel portions of the chassis generally do not include OCP bays capable of receiving OCP modules. As noted above, the front panel of many servers is often occupied by drive cages which have drive bays therein for receiving hot-swappable storage drives. These drive bays, however, are not compatible with OCP modules. Generally, a given type of bay is configured to receive only a specific form factor of pluggable module (or family of form factors). For example, an Enterprise and Data Center Standard Form Factor (EDSFF) E3.S drive bay may be configured to receive a EDSFF E3.S drive, but might not be capable of receiving another storage drive having a different form factor, such as U.2 Small Form Factor (SFF), much less an entirely different type of module such as an OCP NIC module.

Because the drive bays at the front panel of a server are not compatible with OCP modules, to provide OCP modules at the front panel of a server may require the design and manufacture of a new chassis which has front panel OCP bays. While theoretically possible, this would be costly. In addition, a separate chassis design having storage drive bays in the front panel instead of the OCP-bays may still need to be produced, as not all customers are going to want OCP modules at the front panel. Consequently, the manufacturer may need to produce and stock at least two (possibly more) different chassis in order to facilitate these different server configurations. This complicates manufacturing and increases logistical costs (e.g., because multiple stock-keeping-units (SKUs) may be needed for the different chassis).

To address these and other issues, disclosed herein is a configurable drive cage system, which is selectively configurable to receive storage drives, OCP modules, or both. This configurable drive cage system comprises a drive cage, at least one adapter, and at least one modular backplane. The drive cage can be disposed at a front panel of a computing system and comprises a number of bays configured to receive either a storage drive (without the adapter) or an OCP module (with the adapter). The modular backplanes are removably connectable to the drive cage, with a drive backplane being used for bays which are to receive storage drives and an OCP backplane being used for bays which are to receive OCP module. In this manner, the configurable drive cage system can be configured to receive: (a) only storage drives, by installing only drive backplanes on the drive cage; (b) only OCP modules, by installing only OCP backplanes and using the adapters for the OCP modules; or (c) a combination of drives and OCP modules, by installing drive backplanes for some bays and OCP backplanes for other bays and using the adapters for the OCP modules.

Moreover, because the drive cage can be disposed at the front panel of the computing system, and because the drive cage can be configured to receive OCP modules, this allows for OCP modules to be positioned at the front panel of the computing system. This OCP-in-front configuration is also facilitated by the OCP backplane. In some examples, the OCP backplane comprises a supporting panel and OCP connectors attached to the supporting panel, with the OCP connectors being connected to cables. These cables are connected to the system board, and can be routed around any intervening components, such as fans, thus allowing for the connection of the front-located OCP modules to the system board notwithstanding these obstacles.

Furthermore, because the configurable drive cage system can be configured to receive drives, OCP modules, or both drives and OCP modules, a variety of different server configurations can be accommodated utilizing the same single chassis design. This can save on development, manufacturing, and logistics costs, as only one chassis design needs to be developed, only one set of tooling may need to be produced, and only one SKU may be needed for the chassis.

In addition, the configurable drive cage system may allow for users to upgrade or reconfigure their system post manufacture. For example, if they initially purchased a system configured to receive only storage drives at the front panel and later desire to add the capability to receive an OCP module, the user may be able to reconfigure their system to receive the OCP module by replacing one of the drive backplanes with an OCP backplane and using the adapter on the OCP module.

In some examples, the drive cage comprises bays configured to receive a particular form factor of storage drive, such as an EDSFF E3.S storage drive in some examples. In some instances, the adapter is configured to be attached to an OCP module and, when so attached, to facilitate the insertion of the OCP module into a bay of the drive cage, with the adapter engaging with the engagement features of the drive cage. The adapter may, for example, have internal engagement features which are complementary to, and engage with, engagement feature of an OCP module, and external engagement feature which are complementary to, and engage with, engagement features of the drive bay (e.g., and EDSFF E3.S drive bay). In this manner, the adapter allows for the engagement features of the bay to guide and support the OCP module notwithstanding the OCP module lacking engagement feature which are complementary to those of the bay.

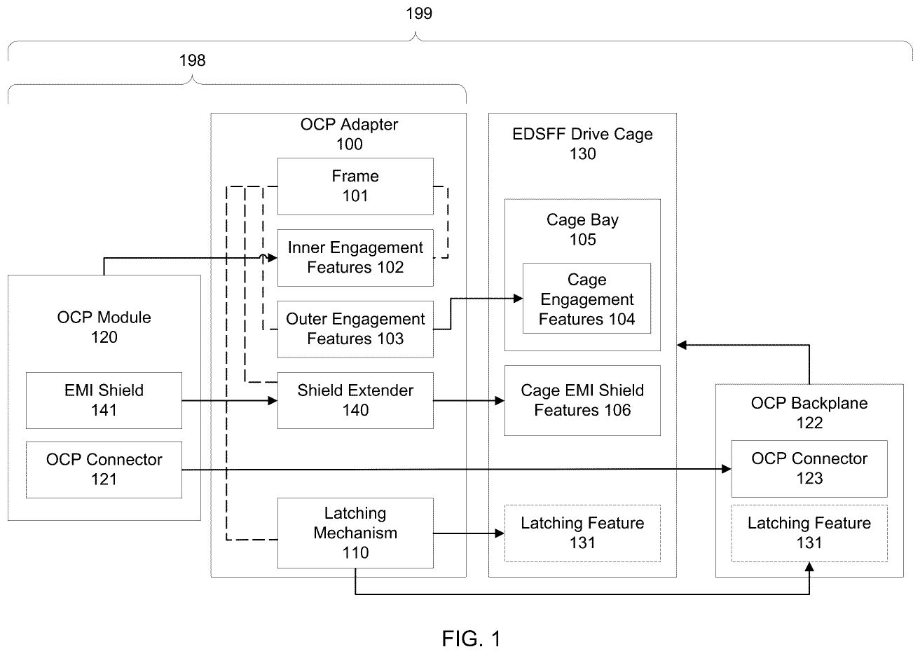

These and other examples will be described in greater detail below in relation to FIGS. 1-9.

Now referring to FIG. 1, an OCP adapter 100 for an EDSFF drive cage 130 is presented. The OCP adapter 100 is illustrated in association with EDSFF drive cage 130 and an example OCP module 120 for context. FIG. 1 also illustrates an OCP module/adapter assembly 198 comprising the OCP module 120 mounted to the OCP adapter 100 and a system 199 comprising the EDSFF drive cage 130 and the assembly 198. The OCP adapter 100, the assembly 198, and the system 199 are described simultaneously below for ease of understanding, but it should be understood that the adapter 100, the assembly 198, and the system 199 may be produced or sold separately or together and may be claimed separately or together herein.

In instances, OCP adapter 100 includes a frame 101. A “frame,” as used herein, is an enclosure configured to engage with other structures that houses and secures components. In an example, a frame 101 of an OCP adapter 100 is configured to house and secure various components of an OCP module. In particular, the frame 101 includes a number of rails connected together to form a generally rectangular profile. The rails may include two side rails which extend along (parallel to) to a first dimension and a rear cross-rail which extends along (parallel to) a second dimension perpendicular to the first dimension, with the rear cross-rail being connected to the rear end portions of both of the side rails. Additional cross-rails extending along the second dimension and connecting to the two side rails may also be included, such as a front cross-rail connected at or near front end portions of the side rails or one or more intermediate cross-rail connected at middle portions of the side rails. The rails may partially encompass and thereby define an interior volume of the frame 101, which is sized and shaped to receive an OCP module 120 disposed therein.

Frame 101 includes inner engagement features 102. In instances, inner engagement features 102 are configured to engage with an OCP module 120 received in the interior volume and to attach adapter 100 to OCP module 120. An “OCP module,” as used herein, is an external component that is consistent with OCP form factor. For example, OCP module 120 may be an OCP NIC 3.0 module. In some instances, inner engagement features 102 are part of the same structure as frame 101 (e.g., part of one of the rails). In some instances, inner engagement features 102 may be attached to frame 101 (e.g., attached to one of the rails). The inner engagement features 102 include at least two inner engagement features 102 which are disposed on or formed in inwardly-facing surfaces of two side rails of the frame 101, respectively, which face into the interior volume. The inner engagement features 102 may be dimensioned and shaped to mimic the rails defined by OCP, and thus may engage with the OCP module 120 in a similar fashion as such rails. In instances, inner engagement features 102 may include one or more grooves configured to engage lateral edges of a Printed Circuit Board (PCB) of OCP module 120. In some examples in which the inner engagement features 102 comprise grooves, the grooves may be recessed into the inwardly facing surfaces of the side rails of the frame 101. In some examples in which the inner engagement features 102 comprise grooves, the grooves may extend along (parallel to) the first dimension, i.e., parallel to the side rails of the frame 101. For example, inner engagement features 102 may secure an OCP module 120 to OCP adapter 100. When the OCP module 120 is secured to the OCP adapter 100, this forms assembly 198.

Frame 101 includes outer engagement features 103. In instances, outer engagement features 103 are configured to engage with engagement features 104 of a cage bay 105 of the EDSFF drive cage 130 as OCP adapter 100 is inserted into the bay 105. In some instances, outer engagement features 103 are part of the same structure as frame 101 (e.g., part of one of the rails). In some instances, outer engagement features 103 may be attached to frame 101 (e.g., attached to one of the rails). The outer engagement features 103 face outwardly, i.e., they face surfaces of the drive cage 130 when the OCP adapter 100 is inserted therein. The outer engagement features 103 may be dimensioned and shaped to mimic the engagement features of the EDSFF drives and thus may engage with the cage engagement features 104 of the bay 104 in a similar fashion as the EDSFF drives. The outer engagement features 103 may slidingly engage with the cage engagement features 104 as the OCP adapter 100 is inserted into the bay 105, with the engagement constraining the freedom of movement of the OCP adapter 100 to substantially only translation along an insertion/removal axis. The engagement between the outer engagement features 103 and the cage engagement features 104 aligns and guides the OCP adapter 100 into a proper installation position and orientation during the insertion. In addition, the engagement between the outer engagement features 103 and the cage engagement features 104 physically supports the OCP adapter 100, relative to the drive cage 130, once installed.

In some instances, outer engagement features 103 comprise one or more protrusions (e.g., tabs, posts, flanges) and the cage engagement features 104 of the bay 105 may define complementary grooves or slots. Thus, the protrusions of the outer engagement features 103 may engage with (extend into) the grooves or slots defined by cage engagement features 104 when the OCP adapter 100 is inserted into the bay 105. In some instances in which the outer engagement features 103 include protrusions, the protrusions may be formed by the side rails of the frame 101 themselves, i.e., the side rails themselves extend into the groove/slots of the bay 105, with an outer face, a top face, and a bottom face of the side rail abutting opposing surfaces of the groove/slot. In other instances, instead of the protrusions being formed by the rails themselves, the protrusions may be formed features which protrude outwardly from the rails. In some examples in which the cage engagement features 140 define grooves, the grooves may comprise recesses which are recessed from surfaces of the drive cage 130 which extend along an insertion direction of drives into the drive cage 130. In some examples in which the cage engagement features 140 define slots, the slots may be defined by protrusions protruding from the surfaces of the drive cage 130 into the bay 105, with the space between a pair of the protrusions forming one of the slots; such protrusions which define the slots 104 may include, for example, flanges which are bent from the walls which define the cage 130, posts attached to the cage 130, or any other protrusion.

In other instances, outer engagement features 103 may include one or more grooves/slots and the cage engagement features 104 may include one or more complementary protrusions configured to engage one another.

Continuing to refer to FIG. 1, adapter 100 includes a latching mechanism 110 connected to frame 101. In instances, latching mechanism 110 may be mechanically connected to frame 101. In instances, latching mechanism 110 and frame 101 may be a monolithic structure. In an example, without limitations, adapter 100 may be a single plastic piece that includes both frame 101 and latching mechanism 110. In some examples, latching mechanism 110 may be connected to a rear portion of the frame, such as to a rear cross-rail of the frame 101 or to rear end portions of one or more side rails of the frame 101. In other examples, latching mechanism 110 may be connected to front portion of the frame 101, such as to a front cross-rail of the frame 101 or to front end portions of one or more of the side rails of the frame 101.

In instances, latching mechanism 110 is configured to latch into a latching feature 131 of the EDSFF drive cage 130 in an installed state of OCP adapter 100. In instances, the installed state may include a connection of OCP connector 121 of OCP module 120 to an OCP bay 123 of backplane 122. An “OCP connector,” as used herein, is an integrated connector complying with an OCP specification and used for connecting OCP external components and devices. In instances, latching feature 131 may be located on drive cage 130. In some instances, latching feature 131 may be attached to drive cage 130. In some examples, latching feature 131 may be located on backplane 122. For example, without limitations, latching feature 131 may be located on backplane 122 attached to drive cage 130. In some instances, latching mechanism 110 may be configured to engage with latching features 131 located on drive cage 130 and/or a backplane 122.

In some instances, latching mechanism 110 may include a recess (e.g., groove, aperture, etc.) configured to snap into a protrusion (e.g., ridge) of latching feature 131. In some instances, latching mechanism 110 may include a protrusion (e.g., ridge) configured to snap into a recess (e.g., groove) of latching feature 131. In some instances, latching mechanism 110 and latching feature 131 may both include protrusions (e.g., ridges) configured to engage one another. In an example, a groove of latching mechanism 110 may latch by receiving a ridge of latching feature 131. In this example, without limitations, groove of latching mechanism 110 moves downward from ridge of latching feature 131 in order to disengage adapter 100 from EDSFF drive cage 130. In instances, latching mechanism 110 and latching feature 131 may include vertical edges configured to contact each other. For example, vertical edges may need to be physically moved sideways, moving the edges away from each other, to disengage adapter 100 from drive cage 130.

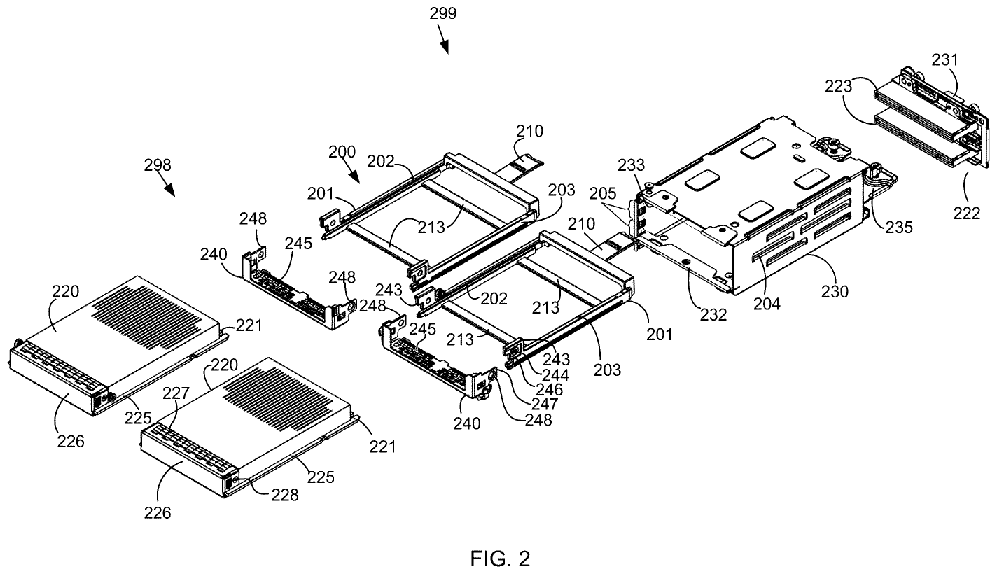

In instances, latching mechanism 110 may include a first latch and a second latch, where each latch is configured to engage with at least one latching feature 131 of EDSFF cage 130. In instances, latching mechanism 110 may be configured to disengage latching feature 131 by moving first latch and second latch towards each other. In instances, latching mechanism 110 may be configured to disengage latching feature 131 by moving first latch and second latch away from each other. Examples of latching mechanism 110 are further described in reference to FIGS. 2-7.

Continuing to refer to FIG. 1, OCP adapter 100 may include an EMI shield extender 140. An “EMI shield extender,” as used herein, is a component configured to contact an EMI shield (or other component with electromagnetic interference shielding capabilities) and to extend the EMI shielding thereof along a given dimension. Generally, information processing devices include an electrically conductive (metal) chassis which houses and supports the components. One function of the chassis is to reduce the electromagnetic interference (EMI) emitted by the device and/or to reduce the EMI admitted into the device from adjacent EMI sources. However, openings in the chassis, such as the openings in bays through which storage drives or other modules are inserted, can provide a route for EMI to exit and enter the device and thus degrade the EMI shielding provided by the chassis. To avoid this issue, removable modules (e.g., storage drives, OCP modules, etc.) generally include EMI shielding features which comprise electrically conductive elements (e.g., EMI spring fingers) which physically engage and electrically connect with EMI shielding features of adjacent removable modules and/or EMI shielding features of the drive cage, when the module is installed. Because the EMI shielding features of all of the installed removable modules are electrically connected to each other and to the chassis, they form, in essence, a large conductive body which can block out EMI. Note that merely covering up the bays with the EMI shielding features of the modules but without electrically interconnecting the those EMI shielding feature to one another and to the cage would generally not be sufficient, as unconnected portions of the EMI shielding features may act like an antenna which allows EMI to pass therethrough. This leakage is avoided by ensuring that the EMI shielding features of each module are electrically connected to the EMI shielding features of all adjacent component (modules or drive cage), thus forming (in essence) a single unbroken EMI shield.

However, one issue that can be encountered which installing an OCP module 120 into an EDSFF drive cage 130 is that the EMI shielding features of the OCP module 120 are generally designed according to the dimensions of an OCP bay, and these dimensions may be smaller than those of the cage bay 105. Specifically, a faceplate of the OCP module 120 comprises an EMI shield 141, and this EMI shield 141 may include engagement interfaces which may comprise EMI spring fingers. These engagement interfaces are arranged on at least top and bottom edges of the EMI shield 141 and positioned so that they can contact and electrically connect with corresponding EMI spring fingers of the OCP bay opening. But because the OCP bay is smaller than the bay 105, when an OCP module 120 is installed in an EDSFF drive cage 130, at least one engagement interface of the EMI shielding features 141 may not be in physical contact with the EMI shielding features 106 (e.g., a shield gasket) of the drive cage 130 or with the EMI shielding features of an adjacent module. This results in there being a gap in the EMI shielding through which some EMI may leak.

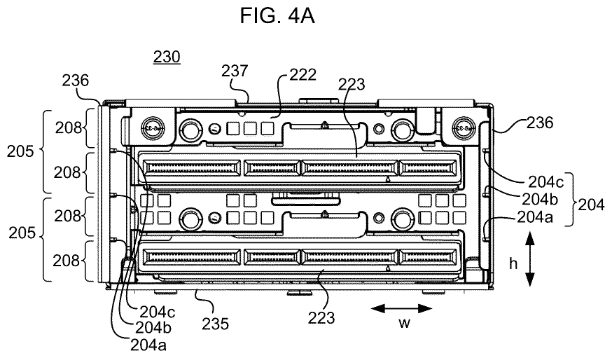

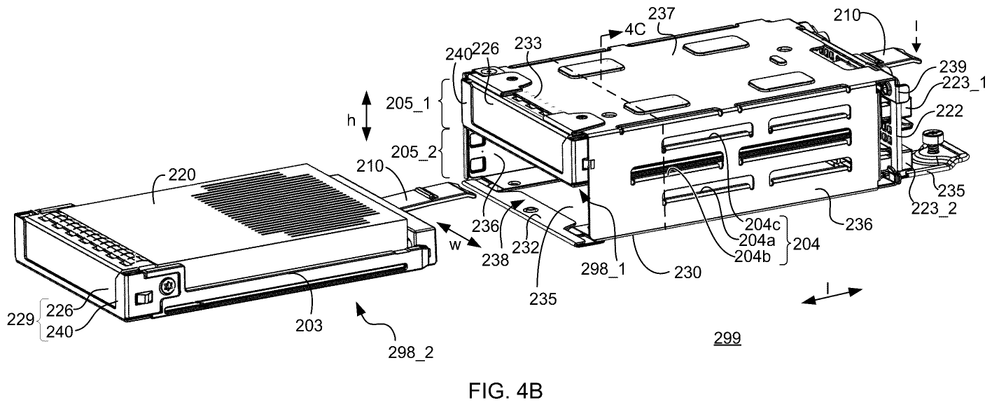

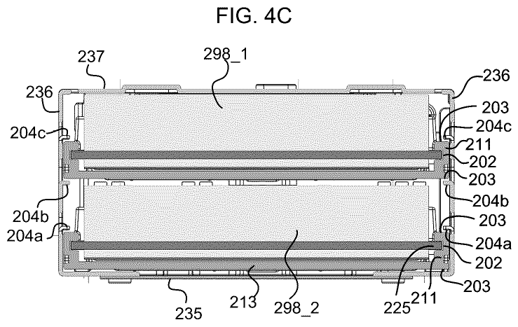

Accordingly, in some examples, the EMI shield extender 140 is provided to ensure that there is no gap in the EMI shielding. The EMI shield extender 140 is attached to the frame 101 and/or to the OCP module 120 and is electrically connected to the EMI shield 141 of the OCP module 120 when the OCP module 120 is installed in the adapter 100. The EMI shield extender 140 is configured to sit between the EMI shield 141 of the OCP module 120 and the cage EMI shield features 106 (or the EMI shield features of an adjacent module) when the adapter 100 with the OCP module 120 mounted thereto is installed in a bay 105 of drive cage 130, with the EMI shield extender 140 being electrically connected to both EMI shield 141 and cage EMI shield features 106 (or EMI features of adjacent module). For example, in some instances the bottom edge of the EMI shield 141 of the OCP module 120 may be positioned a certain distance above the bottom of the bay 105, and thus the bottom edge of the EMI shield 141 does not connect to cage EMI shield features 106 or to the EMI shield features of another module positioned in an adjacent bay 105 below the OCP module 120; however, in such a case, the EMI shield extender 140 may sit below the EMI shield 141 and electrically connect the EMI shield 141 to the cage EMI shield features 106 (or EMI features of the adjoining module). Directional terms such as “above” and “below” are used here relative to the orientation depicted in the figures, and not intended to denote orientation relative to the ground or some other external reference frame. Thus, for example, if the drive cage 230 were oriented relative to the ground at an orientation rotated 90-degrees relative to the orientation depicted in FIG. 4B, then directions referred to as “above” and “below” herein would become “left” and “right” when considered relative to the ground.

In instances, EMI shield extender 140 may include springs. For example, springs may allow for the contact of EMI shield extender with multiple types of components without requiring that the size to be exact. By having the springs, EMI shield extender 140 may interact with different objects without requiring that the object and EMI extender 140 be a perfect fit. This also facilitates easy insertion and removability of the OCP module 120. Shield extender 140 may be configured to contact an EMI shield 141 of an OCP module 120. Shield extender 140 may be further configured to engage with a shield gasket of EDSFF drive cage 142. In some instances, springs are located at the bottom of shield extender. In instances, springs may be located at the top of shield extender. Orientations are described herein relative to EDSFF drive cage 130. EMI shield and EMI gasket are described in more detail below.

The combination of the EDSFF drive cage 130 with the OCP backplane 122 attached thereto together with the assembly 198 (comprising OCP adapter 100 and OCP module 120 mounted thereto) forms system 199. The system 199 may be part of an information processing device, which may also comprise other components (not illustrated) as would be familiar to those of ordinary skill in the art, such as a chassis, a processor, etc. One or more of the other components (e.g., processor) may be electrically connected to the OCP connector 123 of OCP backplane 122 (e.g., via a cable), thus enabling communication between the OCP module 120 and the other components of the information processing device.

Now referring to FIGS. 2-5, an example OCP adapter 200 will be described. The OCP adapter 200 is illustrated in association with an example EDSFF drive cage 230 and an example OCP module 220 for context. FIGS. 2-5 also illustrate an OCP module/adapter assembly 298 comprising the OCP module 220 mounted to the OCP adapter 200 and a system 299 comprising the EDSFF drive cage 230 and the assembly 298. The OCP adapter 200, the assembly 298, and the system 299 are described simultaneously below for ease of understanding, but it should be understood that the adapter 200, the assembly 298, and the system 299 may be produced or sold separately or together and may be claimed separately or together herein. OCP adapter 200 is an example implementation of OCP adapter 100. OCP adapter 200 may include any or all components of adapter 100. Components of adapter 200 correspond to (i.e., are example implementations of) respective components of adapter 100. For example, frame 201 may correspond to frame 101. Corresponding components are given reference numbers having the same last two digits herein, such as 201 and 101. Similar, OCP module 220 and EDSFF drive cage 230 are example implementations of OCP module 120 and EDSFF drive cage 130.

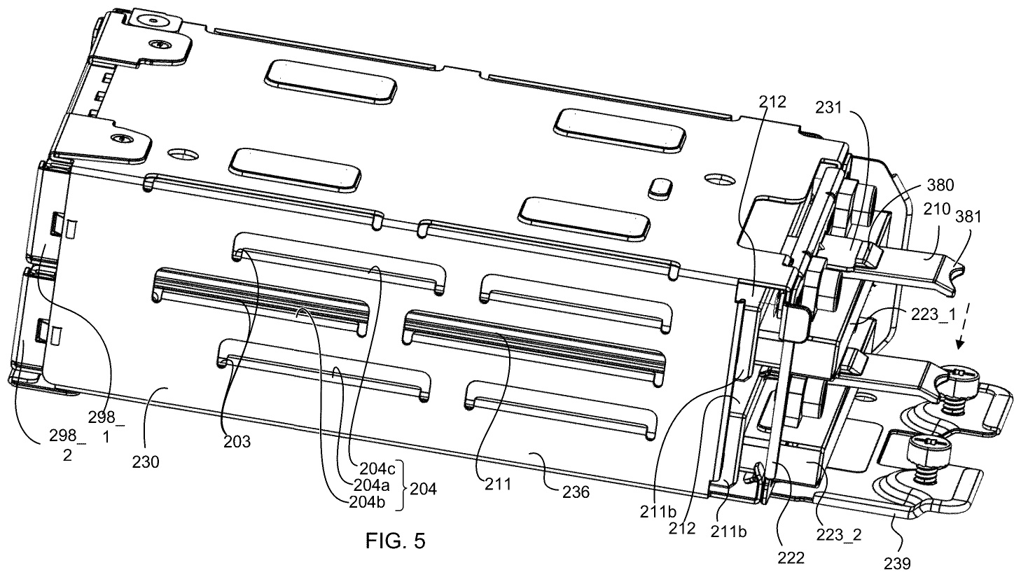

As shown in the exploded view of FIG. 2, in this example of the system 299 the drive cage 230 comprises two bays 205, and hence two OCP adapters 200 and two OCP modules 220 are illustrated for insertion into those bays 205. The EDSFF drive cage 230 includes cage engagement features 204 which define the bays 205. A backplane 222 is attached to the rear of the EDSFF drive cage 230 and comprises OCP connectors 223 aligned with the bays 205, respectively. Each OCP adapter 200 including a frame 201 with inner and outer engagement features 202-203, a latching mechanism 210, and an EMI shield extender 240. Each OCP module includes a PCB 225, an OCP connector 221, and an EMI shield 226. The adapters 200 with OCP modules 220 mounted thereto are inserted into the bays 205, respectively, with the outer engagement features 234 engaging with the cage engagement features 204 and guiding the OCP modules 220 into installed positions in which the OCP connectors 221 mate with the OCP connectors 223 (the mated state is shown in FIG. 5).

Although a single drive cage 230 is illustrated in FIG. 2 and this drive cage 230 has two bays 205, this is merely an example and in practice an information processing device may include multiple drive cages (including the drive cage 230 or other drive cages) which may have any desired size. In other words, the principles described herein and illustrated in FIG. 2 can be scaled up to any size of drive cage with any number of bays 205, subject to the space constraints of the particular device, such as three or more bays 205. In examples in which another drive cage is used which has more bays, the drive cage may include similar features as the drive cage 230 except with scaled up dimensions and additional instances of features (e.g., additional bays 205 and corresponding engagement features 204).

Further, although the example only shows one backplane 222 with two OCP connectors 221, in instances, the backplane 222 may be replaced with a backplane which includes three or more OCP connectors 221. In some instances, backplane 222 may be replaced with a backplane which may only include one OCP connector 221. In some instances, backplane 222 may be replaced by a backplane which includes one or more other connectors, such as EDSFF connectors. For example, backplane 222 may be replaced with another backplane that includes one OCP connector 221 aligned with one bay 205 and one EDSFF connector (not illustrated) aligned with the other bay 205, which would allow the drive cage 230 to receive one OCP module 220 (with one adapter 200) and one EDSFF drive (not illustrated) instead of receiving two OCP modules 220. Furthermore, the backplane 222 could be replaced with a different backplane which comprises only EDSFF connectors, in which case EDSFF drive 230 would be configured to receive only EDSFF modules. Thus, the EDSFF drive cage 230 can be reconfigured to receive OCP modules, EDSFF drives, or combinations of OCP modules and EDSFF modules by selectively attaching a backplane (such as backplane 222) which has the desired connectors to the rear of drive cage 230 and using adapters 200 if/when OCP modules 220 are used. In some examples, multiple drive cages 230 are provided, where only drive cage 230 is configured to receive OCP modules, through the use of OCP adapter 200 and OCP backplane 222 and OCP backplane 22, while the other drive cage 230 may be configured to receive EDSFF drives through the use of a backplane with EDSFF connectors. A person of ordinary skill in the art, upon reading this disclosure, will appreciate the multiple amounts and combinations of connectors possible.

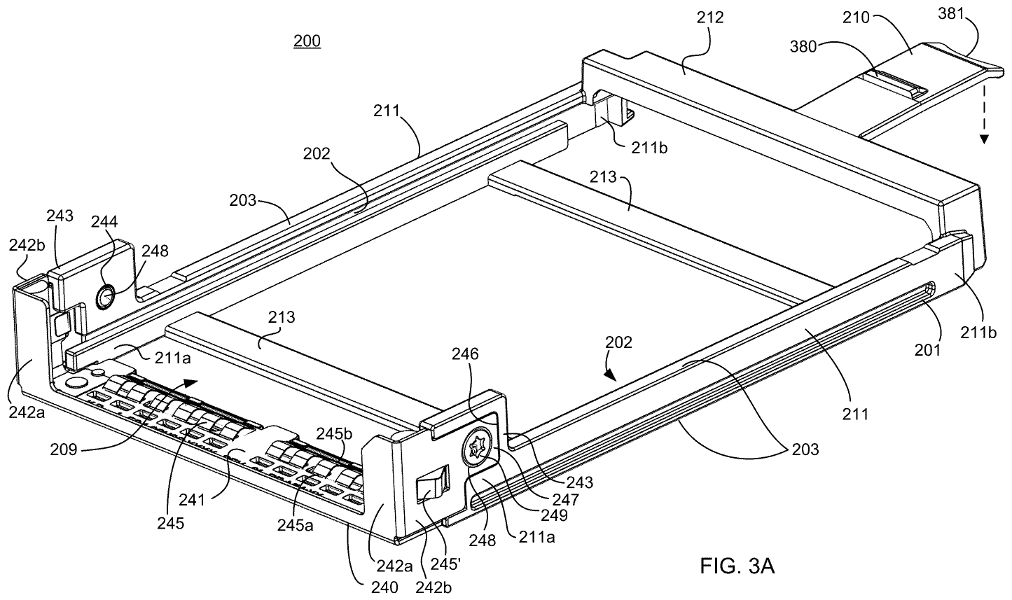

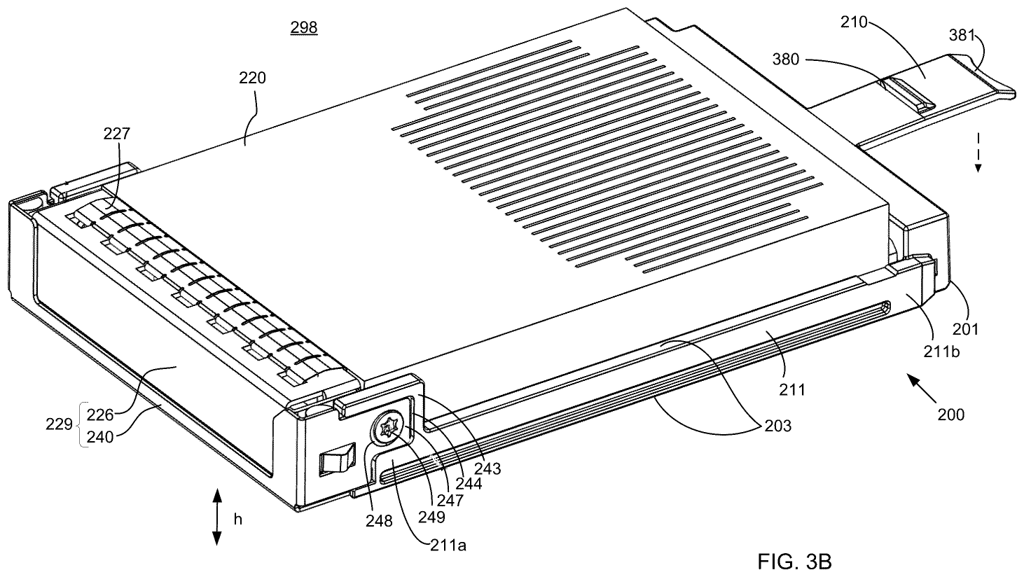

As shown in FIG. 3A, OCP adapter 200 comprises a frame 201 which has two side rails 211 extending along a first dimension, a rear cross-rail 212 attached to a rear end portion 211b of each of the side rails 211 and extending along a second dimension, and two intermediate cross-rails 213 attached to each of the side rails 211 between the front end portion 211a and rear end portion 211b of the side rails 211 and extending along the second dimension. The side rails 211 and rear cross-rail 212 partially encircle and define therebetween an internal space 209 into which the OCP module 220 can be received.

The OCP adapter 200 also comprises two adapter attachment pieces 243, which are coupled to the front end portions 211a of the side rails 211, respectively, as shown in FIGS. 3A and 3B. The adapter attachment pieces 243 extends vertically from the side rails 211. In some examples, the adapter attachment pieces 243 are integrally connected to the side rails 211, meaning they are part of a unitary body. In other examples, the adapter attachment pieces 243 and the side rails 211 are formed as separate parts which are later connected together, such as by mechanical fasteners, interlocking engagement features, or other fastening techniques. The adapter attachment pieces 243 are configured to facilitate attachment of an EMI shield extender 240 (described below) to the adapter 220. Accordingly, each adapter attachment piece 243 comprises a fastener receiver 244 (see FIGS. 2 and 3A) which is arranged to receive a fastener 249 inserted therethrough, with the fastener 249 engaging with the EMI shield extender 240 to securing it to the adapter 220, as shown in FIG. 3A. The adapter attachment pieces 243 may also each include an engagement feature 246 which engages and constrains the EMI shield extender 240. As shown in FIG. 2, the engagement feature 246 comprises a recess in on outward facing surface of the adapter attachment pieces 243, and as shown in FIG. 3A a complementary engagement feature 247 of the EMI shield extender 240 is disposed within the engagement feature 246. In addition to assisting in constraining the orientation of the EMI shield extender 240, the engagement feature 246 may also allow the outer faces of the EMI shield extender 240 to sit flush with or slightly below the outer faces of the frame 201, thus ensuring that there is no interference between the EMI shield extender 240 and the drive cage 230 during insertion.

As noted above, the OCP adapter 200 also includes an EMI shield extender 240. EMI shield extender 240 includes a horizontal plate 241, front walls 242a coupled perpendicularly to the horizontal plate 241, side walls 242b coupled perpendicularly to opposite ends of the horizontal plate 241 and to the front walls 242a, and extender EMI springs 245. The side walls 242b each comprise one of the engagement features 247 mentioned above. The extender EMI springs 245 includes upward facing springs 245 disposed on a top surface of the horizontal plate 241 and downward facing springs 245 disposed on a bottom surface of the horizontal plate 241. The downward facing springs 245 are not visible in the figures but may be configured similarly to the upward facing springs 245 except for facing in opposite directions. The upward and downward facing springs 245 may be electrically connected together. For example, the springs 245 may each comprise a free end 245a and a connected end 245b, with the connected ends 245 of all the springs 245 being connected together and with the upward and downward facing springs 245 being arranged opposite one another in a clam-shell like arrangement, with the horizontal plate 241 sandwiched therebetween. In addition, the EMI shield extender 240 comprises lateral EMI springs 245′ which extend laterally from the side walls 242b.

EMI shield extender 240 is configured to contact an EMI shield 226 attached to OCP module 220 in a state of the OCP adapter 200 attached to the OCP module 220. Specifically, upward facing EMI springs 245 of the EMI shield extender 240 may contact a bottom portion of the EMI shield 226, i.e., downward facing EMI springs on the bottom side of the EMI shield 226. Accordingly, the EMI shield extender 240 is electrically connected to the EMI shield 226 of the OCP module 220 and these together can form a combined EMI shield 229 for the assembly 298. The top EMI springs 227 of the EMI shield 226 form a top interface of the combined EMI shield 229, while the bottom EMI springs 245 of the EMI shield extender 240 form a bottom interface of the combined EMI shield 229. The combined EMI shield 229 extends farther along the height dimension (labeled “h” in FIG. 3B) than does the EMI shield 226 alone. In other words, the bottom interface of the combined EMI shield 229 is located lower than the bottom of the EMI shield 226. This allows the bottom interface of the combined EMI shield 229 to contact the EMI shields of components positioned below the assembly 298 which the EMI shield 226 might not have been able to contact. The EMI shields of components disposed above the assembly 298 may be contacted by the top EMI springs 227 of the EMI shield 226. Thus, the combined EMI shield 229 can contact components both above and below the assembly 298, thus avoiding the creation of a break in the EMI shielding which would occur if only EMI shield 226 were present.

More specifically, the downward facing EMI springs 245 of EMI shield extender 240 are configured to, in an installed state of the assembly 298 into a bay of a cage (e.g., EDSFF cage 230) contact either an a portion of the cage positioned below the assembly 298 (e.g., bottom EMI gasket 232 of the EDSFF cage 230) or an EMI shield of an adjacent module positioned below the assembly 298 (such as EMI shield 226 of another OCP module 220), depending on which bay the assembly 298 is inserted into. In addition, in the installed state of the assembly 298 into a bay of a cage, EMI springs 227 on a top side of EMI shield 226 of the OCP module 220 may contact either a portion of the cage positioned above the assembly 298 (e.g., top EMI gasket 233 of EDSFF cage 230) or an EMI shield of an adjacent module positioned above the assembly 298 (such as EMI shield extender 240 of another adjacent assembly 298). Furthermore, the lateral EMI springs 245′ may contact lateral walls of the cage 230.

For example, assuming that two of the assemblies 298 are inserted into the bays 205 of the drive cage 230, which includes two bays 205 in a vertically stacked configuration, then the EMI shield extender 240 of the top assembly 298 contacts the top EMI springs 227 of EMI shield 226 of the bottom assembly 298, and the EMI shield extender 240 of the bottom assembly 209 contacts the bottom EMI gasket 232. At the same time, the top EMI springs 227 of the EMI shield 226 of the top assembly 298 will contact the top EMI gasket 233 while the top EMI springs 227 of the EMI shield 226 of the bottom assembly 298 will contact the EMI shield extender 240 of the top assembly 298. Thus, an unbroken chain of electrically connected EMI shielding covers the opening of the drive cage 230, which can reduce EMI leakage into or out of the cage 230.

The same principles as described above would apply if an OCP module/adapter assembly 298 were inserted into some other drive cage which has more than two bays. If inserted into the top bay, the combined EMI shield 229 of the assembly 298 would contact the top EMI gasket of the cage and also the EMI shield of the module in the bay immediately below the assembly 298; if inserted into the bottom bay, the combined EMI shield 229 of the assembly 298 would contact the bottom EMI gasket of the cage and also the EMI shield of the module in the bay immediately above the assembly 298; and inserted into one of the intermediate bays, the combined EMI shield 229 of the assembly 298 would contact the EMI shields of the modules in the bays immediately above and below the assembly 298. Note that the adjacent module may be another one of the assemblies 298, or it may be some other module. For example, in some drive cages, EDSFF drives may be positioned in some bays while assemblies 298 comprising OCP modules 220 may be positioned in other bays, and thus an EDSFF drive could potentially be the module which is adjacent an assembly 298. Furthermore, in some cases if it is not desired to install an active device in one of the bays, then a so-called drive blank may be inserted into the bay, and such a drive blank may in some cases be the module which is adjacent to an assembly 298 (a drive blank is a passive module comprising a frame with an EMI shield attached which is configured to be inserted into a bay in lieu of an active module, such as a drive).

Referring to FIGS. 2, 4A-B, 5 and 7, drive cage 230 comprises a box-like housing comprising a bottom plate 235, side walls 236, and a top wall 237. The drive cage 230 has an opening 238 at a front end thereof into which electronic modules, such as assembly 298, may be inserted. As shown in FIGS. 4A and 4B, drive cage 230 further comprises cage engagement features 204. In the illustrated implementation, the cage engagement features 204 comprise protrusions (flanges) which protrude inwardly from the side walls 236. A pair of adjacent cage engagement features 204 defines a groove or slot in the space between the two cage engagement features 204 into which a protrusion of an EDSFF drive or OCP adapter 200 is inserted and along which it extends.

The cage engagement features 204 define single-wide bays 208 and double-wide bays 205. Each single-wide bay 208 corresponds to a volume within the drive cage which extends lengthwise (“I” in FIG. 4B) along the length of the side walls 236, widthwise (“w” in FIG. 4B) along the width of the drive cage 230, and height-wise (“h” in FIG. 4B) between two adjacent cage engagement feature 204. Thus, for example, a bottom most bay 208 corresponds to the space between the bottom plate 235 and an engagement features 204a, another bay 208 corresponds to the space between engagement features 204a and an engagement features 204b, another bay 208 corresponds to the space between engagement features 204b and an engagement features 204c, and a top-most bay 208 corresponds to the space between engagement features 204c and the top wall 237. Each double wide bay 205 corresponds to a volume comprising two of the single-wide bays 208. Thus, a bottom bay 205 corresponds to the space between the bottom plate 235 and the engagement features 204b, a top bay 205 corresponds to the space between engagement features 204b and the top wall 237.

The distance between a pair of adjacent cage engagement features 204 corresponds to (i.e., is equal to or slightly larger than) the width of engagement features of an EDSFF drive, and therefore a single-wide bay 208 can receive one EDSFF drive. As an EDSFF drive is inserted into a bay 208, it engages with a pair of adjacent cage engagement features 204 on one side wall 236 and another corresponding pair of engagement features 204 on the opposite side wall, and the engagement features 204 align the EDSFF drive and guide it into a proper installed position in which the drive can blind mate with an electrical connector. More specifically, the engagement features of the EDSFF drive are inserted into the slot or groove defined between the pairs of engagement features 204 and slides along that slot/groove.

The external engagement features 203 of the adapter 200 are also configured to engage with pairs of adjacent engagement features 204 in a similar fashion when inserted into a bay 205. Specifically, in the illustrated implementation, the external engagement features 203 are formed by the top and bottom surfaces of the side rails 211 of the adapter 200, and the distance between these surfaces is equal to the width of the engagement features of an EDSFF drive. In other words, the distance between top and bottom surfaces of each side rail 211 is equal, or slightly smaller than, the distance between two adjacent engagement features 204. Thus, as shown in FIG. 4C, if an assembly 298_2 is inserted into a bottom bay 205_2, the engagement feature 203 formed by the top surface of the side rail 211 engages with cage engagement feature 204b while the engagement feature 203 formed by the bottom surface of the side rail 211 engages with bottom plate 235, and the cage engagement feature 204b aligns and guides the assembly 298_2 into a proper installed position in which the OCP connector 221 of OCP module 220 blind mates with a corresponding top OCP connector 223_1 of the backplane 222. In other words, the engagement feature 203 formed by one of the side walls 211 is inserted into the slot/groove defined between the bottom plate 235 and one of the cage engagement features 204b, and the side walls 211 slide along this slot/groove. Similarly, if an assembly 298_1 is inserted into a top bay 205_1, the engagement feature 203 formed by the top surface of the side rail 211 engages with top wall 237 while the engagement feature 203 formed by the bottom surface of the side rail 211 engages with cage engagement feature 204b, and the cage engagement feature 204b aligns and guides the assembly 298_1 into a proper installed position in which the OCP connector 221 of OCP module 220 blind mates with a corresponding bottom OCP connector 223_2 of the backplane 222. In other words, the engagement feature 203 formed by one of the side walls 211 is inserted into the slot/groove defined between the top wall 237 and one of the cage engagement features 204b, and the side walls 211 slide along this slot/groove.

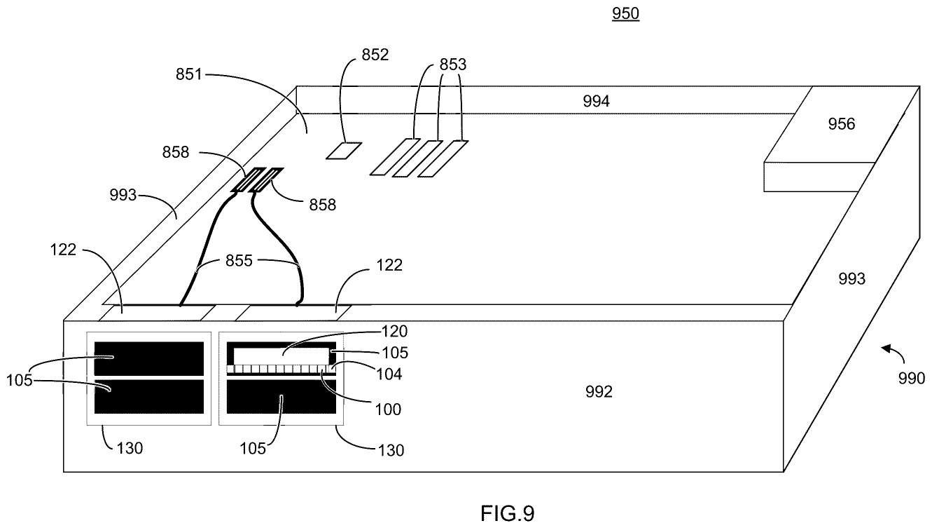

Backplane 222 may be attached to the drive cage 230. Specifically, brackets 239 may be coupled to the top wall 237 and/or side walls 236, and the backplane 222 may be coupled to these brackets via fasteners (not illustrated). Backplane 222 may also engage with a portion of the bottom plate 235 which extends rearward beyond the side walls 236. Bottom plate 235 may also secure drive cage 230 and backplane 222 to a chassis of an information processing device, such as described in reference to FIG. 9. Although not illustrated, other backplanes could be attached to drive cage 230 in lieu of the backplane 222. For example, a backplane comprising connectors capable of connecting to EDSFF drives may be mounted to the drive cage 230 instead of the backplane 222, which would configure the drive cage 230 to receive EDSFF drives. Alternatively, another backplane which comprises one OCP connector 223 and one or more EDSFF connectors may be attached to the drive cage 230, which would configure the drive cage 230 to receive a combination of an OCP module 220 (with adapter 200) and one or more EDSFF drives.

As noted above, the drive cage 230 also comprises bottom and top EMI gaskets 242 and 243. In some instances, bottom and top EMI gaskets 242 and 243 may be formed by a portion of the bottom plate 235 and top wall 237, respectively, which are electrically conductive. In other instances (not illustrated), bottom and top EMI gaskets 242 and 243 may comprise pieces which are separate from and attached to bottom plate 235 and top wall 237. As described above, bottom EMI gasket 242 is configured to contact EMI shield extender 240 of an assembly 298 installed in the bottom bay 205_2, specifically the bottom facing extender springs 245 are configured to contact bottom EMI gasket 242. Top EMI gasket 243 is configured to contact EMI shield 226 of an assembly 298 installed in the top bay 205_1, specifically top EMI springs 227.

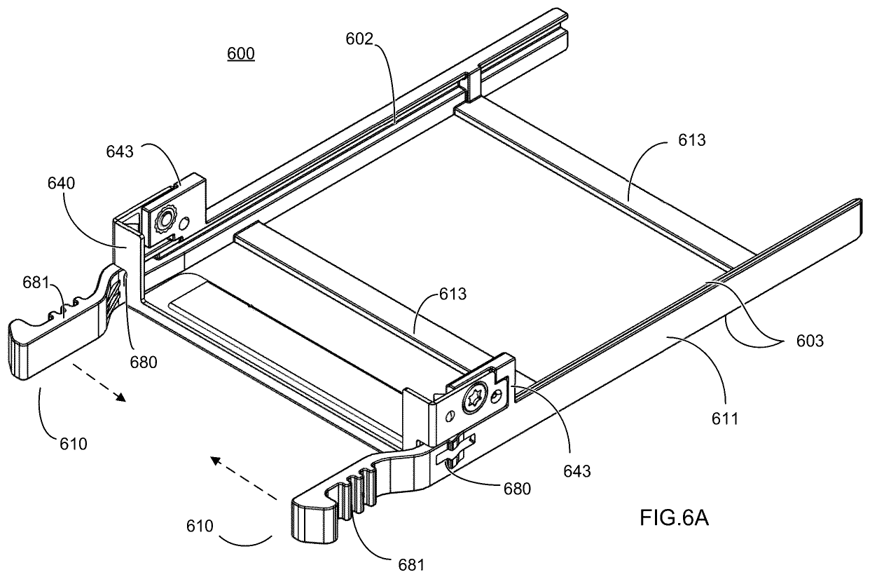

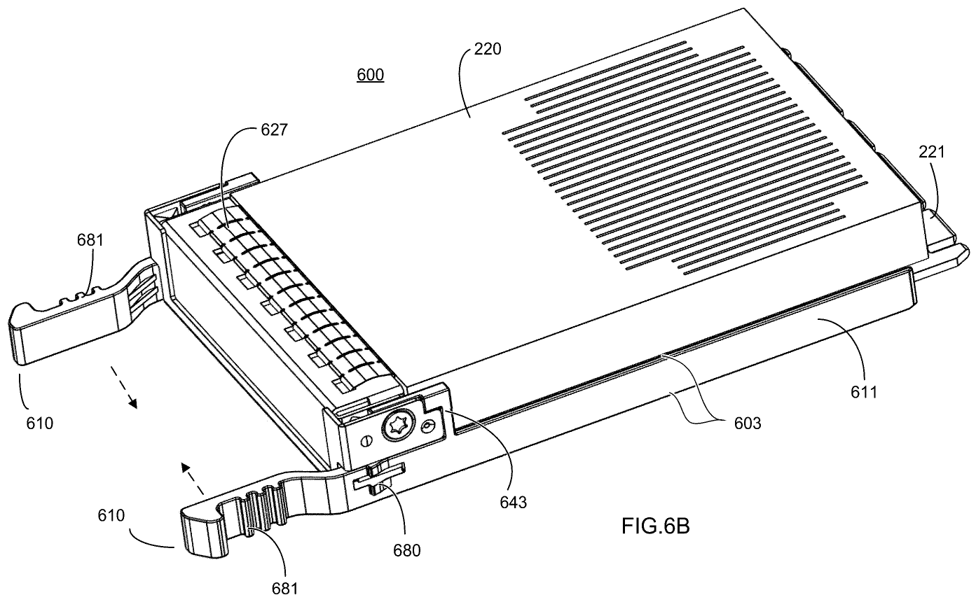

Referring to FIGS. 2, 3A-B, 4B and 6A-B, frame 201 may include an adapter attachment piece 243. As used herein, “adapter attachment piece” is a component used for securing OCP module 220 and/or shield extender 140 to OCP adapter 200. In instances, referring to FIGS. 6A-B, adapter attachment piece 243 may further secure latching mechanism 210 to OCP adapter 200. With reference to FIGS. 2, 3, 3A and 6A, frame 201 may include crossbars 213 used for providing stability to frame 201 and connecting the inner and outer engagement features 202-203 of each side of frame 201. In instances, frame 201 may include one crossbar 213. Frame 201 may include two or more crossbars 213. In some instances, crossbar 213 may be attached to frame 201. In instances, crossbar 213 may be a part of the same structure as frame 201. For example, crossbar 213 and frame 201 may be a monolithic plastic piece.

Now referring to FIGS. 3A and 3B, an example OCP module adapter 200 with a rear-side latching mechanism 210 is presented. Rear-side orientation is used herein in reference to EDSFF cage 230, with the rear end thereof being the end to which the backplane 222 is attached and the front end being the end with opening 238. In this example, latching mechanism 210 includes a handle 381. Handle 381 includes a protrusion 380 that is sloped shaped on one end for allowing for insertion of adapter 300 into a cage, while providing an obstruction on the other end as to prevent disengagement of adapter 300 from a cage. As shown in FIG. 5, the protrusion 380 engages with latching feature 231 which is attached to cage 230 and/or backplane 222, which prevents movement of the adapter 200 out of the cage 230. In this example, with reference to FIG. 5, external force is applied downwards (shown in dashed line) to provide move the protrusion 380 below the latching feature 231 and provide clearance of the obstruction relative to the latching feature 231, and while pressed down, adapter 300 is moved away from backplane 222.

Referring to FIG. 4B, OCP adapter 200 is inserted into a cage bay 205 of drive cage 230. In this example, an OCP adapter 200 with an OCP module 220 attached is shown in an uninstalled position while another OCP module 220 attached to an OCP adapter 200 is shown inserted into the top cage bay 205 of drive cage 230.

Now referring to FIG. 5, an example with two OCP adapters 200 are shown in the installed position. In this example, backplane 222 is shown attached to drive cage 230 and bottom plate 235. In this example, two handles 381 with protrusions 380 are shown, where to remove the OCP adapters 220, the handles 381 are moved downwards in the direction of the dashed line.

Now referring to FIGS. 6A and 6B, an example OCP module adapter 600 with a front-side latching mechanism 610 is presented. The OCP module adapter 600 is another example implementation of the OCP adapter 100 described above, and is configured to receive the OCP module 200 described above. OCP module adapter 600 may be similar to OCP module adapter 200 in many ways, but they may differ from one another primarily in that OCP module adapter 200 has a rear-side latching mechanism 210 while OCP module adapter 600 has a front-side latching mechanism 610. Inner and outer engagement features 602-603, side rails 611, crossbar 613, top EMI springs 627 and attachment pieces 643 are configured similarly to inner and outer engagement features 202-203, side rails 211, crossbar 213, top EMI springs 227 and attachment pieces 243.

Front-side latching mechanism 610 is one example implementation of latching mechanism 110. Front-side orientation is used herein in reference to EDSFF cage 630. In this example, lateral protrusions 680 are configured to engage with latching features, such as grooves, of an EDSFF cage 630. In this example, protrusions 680 are shaped as to provide a slope shaped end that allows for insertion of adapter 600 into a cage, while providing an obstruction end on the other side of the protrusion 680 as to prevent adapter 600 from disengaging with a cage 630. In this example, handles 681 of latching mechanisms 610 must be physically pressed towards each other as to release latching mechanisms 610 (movement shown in dashed lines). In alternate instances, handles 681 may be configured to be moved away from each other to release latching mechanism 610.

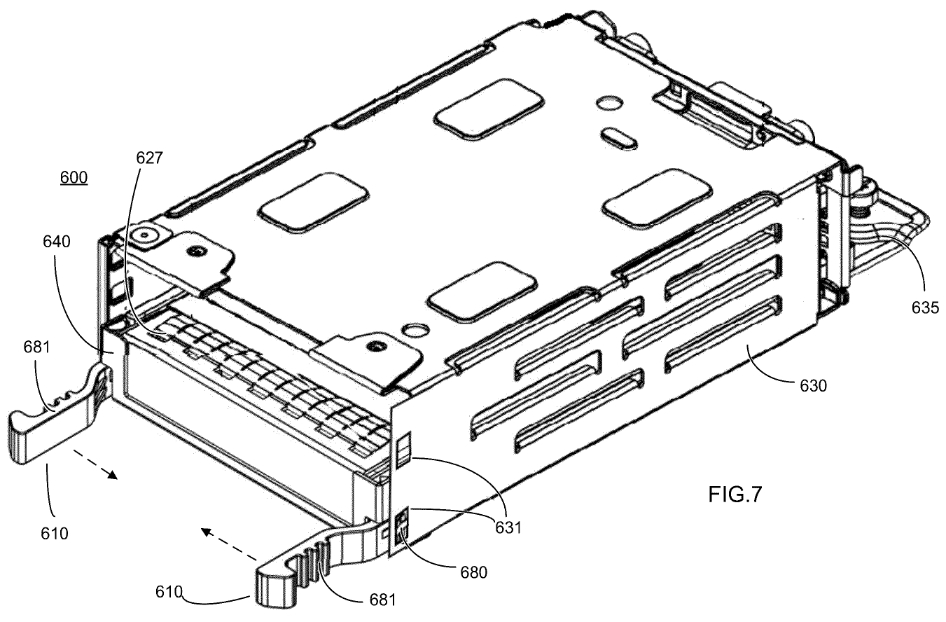

Referring to FIG. 7, a drive cage 630 with an OCP adapter 600 with a front-side latching mechanism 610 in an installed position is shown. The drive cage 630 is similar to the drive cage 230 described above, except that the drive cage 630 further comprises latching feature 631. In this example, protrusions 680 latch to latching feature 631 of drive cage 230. Latching feature 631 is one example implementation of latching feature 131 located in drive cage 130. In this example, once OCP adapter 600 is pushed inward into an installed position, the sloped protrusion 680 is also pushed into a position where it engages with the opening in the drive cage 630, herein the latching feature 631. To disengage protrusion 680 from latching feature 631, handles 681 need to be moved in the direct of the dashed lines.

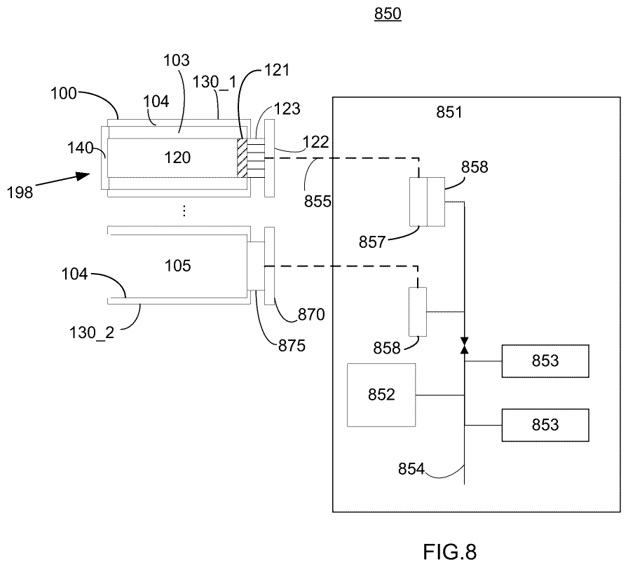

Now referring to FIG. 8, a computing system 850 is presented. In instances, computing system 850 includes a chassis. A “chassis,” as used herein, is an enclosure designed to house and support hardware components. The chassis includes a front panel, a base, a rear panel, a top wall and side panels (which are omitted in this example for illustrative purposes).

Computing system 850, in instances, includes a system board 851. A “system board,” as used in this disclosure, is a central circuit board comprising a central processing unit (CPU) and supporting circuitry, and configured to enable connection and integration among a plurality of components and devices. In examples, system board 851 may include an OCP primary board. In an instance, “OCP primary board,” is a primary board configured for OCP form factor. In some instances, a primary board which complies with OCP form factors may be referred to as a Host Processor Module (HPM).

In some instances, computing system 850 may include a processor 852 mounted to system board 851. As used herein, a “processor” is a component configured for executing instructions, performing calculations and managing tasks. In instances, computing system 850 may include two or more processors 852 mounted to system board 851. In an example, without limitations, processor 852 may be a Central Processing Unit, (CPU).

Still referring to FIG. 8, in instances, computing system 850 includes at least a memory 853 mounted to system board 851. As used in this disclosure, a “memory” is a data storage component configured to store instructions for a computing component, such as processor 852. In examples, without limitations, memory 853 may be configured for temporary storage of data, such as a random-access memory (RAM), or permanent data storage, such as Solid-State drives (SSD).

In instances, continuing to refer to FIG. 8, processor 852 and/or memory 853 may communicate with each other via a bus 854. A “bus,” as used herein, is a component configured for transmitting data. Bus 854 may include multiple types of bus structures, and combinations thereof, such as memory bus, memory controller, peripheral bus, local bus, and the like.

In instances, computing system 850 includes one or more EDSFF drive cages 130 disposed at or forming part of the front panel. In instances, each EDSFF drive cage 130 includes a plurality of EDSFF drive bays 105 configured to receive EDSFF drives or OCP module/adapter assemblies 198 (only one bay 105 is illustrated per drive cage 130, but any number of such bays 105 may be present). In instances, each EDSFF drive bay 105 includes EDSFF-drive-bay engagement features 104 configured to engage with complementary EDSFF-drive engagement features of the EDSFF drives and/or with external engagement features 103 of an OCP adapter 100. Each drive cage 130 is configured to be capable of receiving different backplanes connected thereto, including the OCP backplane 122 illustrated in FIG. 8 which has OCP connectors 123, an EDSFF backplane 870 which has EDSFF connectors 875, a hybrid backplane (not illustrated) which has a combination of OCP connectors and EDSFF connectors, or some other backplane. Depending on which backplane is connected to the drive cage 130, the bays 105 thereof may be configured to receive different types of modules. In the illustrated example, the first drive cage 130_1 has an OCP backplane 122 attached thereto, and thus in this configuration the bays 105 of drive cage 130_1 are configured to receive OCP module/adapter assemblies 198. On the other hand, the second drive cage 130_2 has an EDSFF backplane 870 attached thereto, and thus in this configuration the bays 105 of the drive cage 130_2 are configured to receive EDSFF drives. Either of these drive cages 130 could be reconfigured to receive different types or combinations of modules by installing a different backplane in lieu of the illustrated backplanes. In FIG. 8, the first drive cage 130_1 is illustrated with an OCP module/adapter assembly 198 installed while the second drive cage 130_2 is shown without any module installed for illustrative purposes.

Computing system 850, in instances, includes an OCP backplane 122. In instances, OCP backplane 122 is attached to the drive cage 130 and includes one or more OCP connectors 123 positioned in a subset of bays 105 of the plurality of bays 105.

In instances, computing device 850 includes one or more cables 855 electrically connecting the OCP connectors 123 to system board 851. In instances, one or more cables 855 may communicably connect OCP connectors 123 to system board 851 via bus 854. As used throughout this disclosure, “communicably connected,” also referred herein as “communicably coupling,” is a connection, attachment or linkage between two or more components which allow for reception and/or transmittance of data, or information, between those components. In instances, the one or more cables 855 may be directly connected at one end to the OCP connectors 123 mounted to the backplane 122 and may be directly connected at the other end to second connectors 857. These connectors 857 may be mated to built-in OCP system connectors 858 located in the system board 851. For example, OCP connectors 123 may be provided at the front of computing system 850 by utilizing existing built-in OCP system connectors 858 of the system board 851, connected via cables 855. In some instances, OCP system connectors 858 may include rear-located, relative to chassis, OCP system connectors 858. A person of ordinary skill will appreciate that OCP system boards or motherboards often provide OCP connectors used for connecting to various modules. Using these OCP connectors and cables provides a cost-effective implementation of front located OCP connections using an existing board architecture.

Still referring to FIG. 8, computing device 850 includes an OCP adapter 100 attached to the OCP module 120. In instances, an assembly of OCP adapter 100 and OCP module 120 is received within a given bay of the subset of bays such that adapter engagement features 103 of OCP adapter 100 engage with the EDSFF-drive-bay engagement features 104 of the given bay and OCP connector 121 of the OCP module 120 is connected to one or the OCP bays 123 of backplane 122.

As described above, OCP adapter 100 includes a frame 101, the frame 101 including inner engagement features 102 configured to engage the OCP module 120 received in the interior volume and to attach the OCP adapter 100 to the OCP module 120. In instances, frame includes outer engagement features 103 configured to engage EDSFF-drive-bay engagement features 135 as the OCP module 120 is inserted into a given bay. In instances, adapter 100 may include a latching mechanism 110 connected to the frame 101 and configured to latch into a latching feature 131 of the EDSFF cage 130 in an installed state of OCP adapter 100 in a given bay.

Continuing to refer to FIG. 8, OCP adapter 100 may include an EMI shield extender 140 configured to contact an EMI shield of OCP module 120. In instances, EMI shield extender 140 may be configured to contact an EMI gasket of drive cage 130. In instances, EMI shield extender 140 may contact EMI shields of other OCP modules 120 in installed positions. In some instances, EMI shield extender 140 may contact other EMI shield extenders. For example, without limitations, EMI shield extender 140 attached to a first OCP adapter 100 may be in contact with a portion of an EMI shield of another OCP module 120. In instances, EMI shield extender 140 may be contact with a drive cage EMI gasket. A person of ordinary skill in the art, upon reading this disclosure, will understand that the inside part of EMI extender 140 is in contact with EMI shield 126 of the OCP module 120 installed in OCP adapter 100, while the outside portion of EMI shield extender 140 will be in contact with another EMI shield if multiple OCP modules 120 installed, or with a drive cage 130 EMI gasket, if either only one OCP module installed or if OCP adapter 100 is located an end portion of drive cage 130.

Now referring to FIG. 9, an example computing system 950 is presented. Computing system 950 includes a chassis 990. Chassis includes a base (not shown), and a front panel 992, side panels 993, a rear panel 994 and a top panel (which is omitted to show internal components of computing system 950). Computing system 950 may include a power supply unit 956.

In instances, computing system 950 includes a system board 851. In instances, system board 851 includes a processor 852, at least one memory 853, as well as other components (not shown). In some instances, system board 851 may include OCP and/or PCIe connectors located near rear panel. In instances, computing system 950 may include a backplane 122 with a multiple connector. In instances, computing system 950 includes an OCP backplane 122 with one or more OCP bays (omitted for illustrative purposes). In some instances, OCP backplane 122 may be directly attached to system board 851. For example, OCP backplane 122 may be connected to system bus (not shown). In instances, OCP backplane 122 may be directly connected to OCP system bays 858 attached to, or part of, system board 851 using one or more cable 855. In an example, without limitations, OCP backplane 122 may be directly connected to OCP bays 858 of a system board 851 that does not provide connections at the front. This approach allows for the OCP bays to be provided at front panel 992 on any system board 851 that has OCP bays 858, such as system boards with rear located OCP connectors.

In instances, computing system 950 also includes EDSFF drive cages 130. In this example, only one bay 105 of a subset of four bays 105 of drive cages 130 has an OCP module 120 installed using an OCP adapter 100. A person with ordinary skill in the art would understand that this example would accept any of the OCP adapters described in this disclosure.

In instances, a method is presented. The method includes inserting OCP module 120 into an inner volume of OCP adapter 100, where inserting the OCP module 120 includes engaging OCP module 120 with inner engagement features 102 of OCP adapter 100. The method further includes engaging outer engagement features 103 of OCP adapter 100 with engagement features of a bay of EDSFF drive cage 130.

The method further includes moving OCP adapter 100 through the extent of engagement features of drive cage 130. The method includes, latching at least one latching mechanism 110 of OCP adapter 100 to at least one latching feature 131 of EDSFF drive cage 130. Latching feature 131 may be located on drive cage 130, backplane 122 and or both. For example, latching feature 131 may be located on backplane 122 for an adapter with a rear-located latching mechanism 110. In an example, latching feature 131 may be located on drive cage 130 for a rear-located latching mechanism 110. In an example, latching feature 131 may be located on drive cage 130 for a front-located latching mechanism 110. A person of ordinary skill in the Art will appreciate, upon reading this disclosure, that OCP adapter 100 is configured to utilize preexisting latching features 130 of drive cage 130 and/or backplane 122. For example, both front-located and rear-located configurations may be used. In instances, both rear-located and front-located configurations may be used on the same drive cage 130. For example, an adapter 100 with front-located latching mechanism 110 configuration may be installed on the top part of drive cage 130 while a rear-located latching mechanism 110 configuration may be installed at the bottom part of drive cage 130, and vice versa.

The method may further include engaging EMI shield extender 140 of the OCP adapter 100 with an EMI shield 141 of OCP module 120. The method may also include engaging EMI shield extender 140 of OCP adapter 100 with EMI gasket 142 of EDSFF drive cage 130. The method, alternatively or additionally, may also include engaging EMI shield extender 140 of OCP adapter 100 with EMI shield of another OCP module 120. For example, when two OCP adapters 100 are installed, the bottom located shield extender 140 may be in contact with shield gasket 142, while top located shield extender 140 may be in contact with EMI shield 141 of bottom located OCP module 120.

In the description above, various types of electronic circuitry are described. As used herein, “electronic” is intended to be understood broadly to include all types of circuitry utilizing electricity, including digital and analog circuitry, direct current (DC) and alternating current (AC) circuitry, and circuitry for converting electricity into another form of energy and circuitry for using electricity to perform other functions. In other words, as used herein there is no distinction between “electronic” circuitry and “electrical” circuitry.

It is to be understood that both the general description and the detailed description provide examples that are explanatory in nature and are intended to provide an understanding of the present disclosure without limiting the scope of the present disclosure. Various mechanical, compositional, structural, electronic, and operational changes may be made without departing from the scope of this description and the claims. In some instances, well-known circuits, structures, and techniques have not been shown or described in detail in order not to obscure the examples. Like numbers in two or more figures represent the same or similar elements.

In addition, the singular forms “a”, “an”, and “the” are intended to include the plural forms as well, unless the context indicates otherwise. Moreover, the terms “comprises”, “comprising”, “includes”, and the like specify the presence of stated features, steps, operations, elements, and/or components but do not preclude the presence or addition of one or more other features, steps, operations, elements, components, and/or groups. Components described as coupled may be electronically or mechanically directly coupled, or they may be indirectly coupled via one or more intermediate components, unless specifically noted otherwise. Mathematical and geometric terms are not necessarily intended to be used in accordance with their strict definitions unless the context of the description indicates otherwise, because a person having ordinary skill in the art would understand that, for example, a substantially similar element that functions in a substantially similar way could easily fall within the scope of a descriptive term even though the term also has a strict definition.

And/or: Occasionally the phrase “and/or” is used herein in conjunction with a list of items. This phrase means that any combination of items in the list—from a single item to all of the items and any permutation in between—may be included. Thus, for example, “A, B, and/or C” means “one of {A}, {B}, {C}, {A, B}, {A, C}, {C, B}, and {A, C, B}”.

Elements and their associated aspects that are described in detail with reference to one example may, whenever practical, be included in other examples in which they are not specifically shown or described. For example, if an element is described in detail with reference to one example and is not described with reference to a second example, the element may nevertheless be claimed as included in the second example.

Unless otherwise noted herein or implied by the context, when terms of approximation such as “substantially,” “approximately,” “about,” “around,” “roughly,” and the like, are used, this should be understood as meaning that mathematical exactitude is not required and that instead a range of variation is being referred to that includes but is not strictly limited to the stated value, property, or relationship. In particular, in addition to any ranges explicitly stated herein (if any), the range of variation implied by the usage of such a term of approximation includes at least any inconsequential variations and also those variations that are typical in the relevant art for the type of item in question due to manufacturing or other tolerances. In any case, the range of variation may include at least values that are within ±1% of the stated value, property, or relationship unless indicated otherwise.

Further modifications and alternative examples will be apparent to those of ordinary skill in the art in view of the disclosure herein. For example, the devices and methods may include additional components or steps that were omitted from the diagrams and description for clarity of operation. Accordingly, this description is to be construed as illustrative only and is for the purpose of teaching those skilled in the art the general manner of carrying out the present teachings. It is to be understood that the various examples shown and described herein are to be taken as exemplary. Elements and materials, and arrangements of those elements and materials, may be substituted for those illustrated and described herein, parts and processes may be reversed, and certain features of the present teachings may be utilized independently, all as would be apparent to one skilled in the art after having the benefit of the description herein. Changes may be made in the elements described herein without departing from the scope of the present teachings and following claims.

It is to be understood that the particular examples set forth herein are non-limiting, and modifications to structure, dimensions, materials, and methodologies may be made without departing from the scope of the present teachings.

Other examples in accordance with the present disclosure will be apparent to those skilled in the art from consideration of the specification and practice of the invention disclosed herein. It is intended that the specification and examples be considered as exemplary only, with the following claims being entitled to their fullest breadth, including equivalents, under the applicable law.

What is claimed is:

1. An OCP adapter for an EDSFF drive cage, the adapter comprising:
a frame defining an interior volume and comprising:
inner engagement features configured to engage with an OCP module received in the interior volume and to attach the OCP adapter to the OCP module;
outer engagement features configured to engage with cage engagement features of a bay of the EDSFF drive cage as the OCP adapter is inserted into the bay to guide the OCP adapter into an installed position in the bay; and
a latching mechanism connected to the frame and configured to latch into a latching feature of the EDSFF drive cage in an installed state of the OCP adapter in the bay.

2. The OCP adapter of claim 1, further comprising an EMI shield extender comprising EMI springs, wherein the EMI shield extender is configured to:
contact an EMI shield of the OCP module and positioned above the EMI shield extender in a state of the OCP adapter attached to the OCP module; and
contact a bottom EMI gasket of the EDSFF drive cage or a second EMI shield of an adjacent module positioned below the OCP adapter in the installed state of the OCP adapter in the bay.

3. The OCP adapter of claim 2, wherein in the state of the OCP adapter attached to the OCP module and installed in the bay, the EMI shield of the OCP module contacts a top EMI gasket of the EDSFF drive cage or a third EMI shield of a second adjacent module positioned above the OCP adapter in a state of a second OCP adapter attached to the second OCP module and the installed state of the second OCP adapter in the bay.

4. The OCP adapter of claim 1, wherein the latching mechanism comprises a ridge configured to snap into a latching feature of the EDSFF cage.

5. The OCP adapter of claim 1, wherein the latching mechanism comprises a groove configured to snap into a latching feature of the EDSFF cage.

6. The OCP adapter of claim 1, wherein the latching mechanism is located at the rear-end of the frame.

7. The OCP adapter of claim 1, wherein the latching mechanism is located at the front-end of the frame.

8. The OCP adapter of claim 1, wherein the latching mechanism comprises a first latch and a second latch.

9. The OCP adapter of claim 7, wherein the latching mechanism is configured to disengage the latching feature as a function of moving the first latch and the second latch towards each other.

10. The OCP adapter of claim 1, wherein the inner engagement features comprise one or more grooves configured to engage lateral edges of a PCB of the OCP module.

11. The OCP adapter of claim 1, wherein the cage engagement features of the bay comprise protrusions protruding inwardly from walls of the EDSFF drive cage and defining slots between pairs of adjacent cage engagement features or between one of the cage engagement features and a wall of the EDSFF drive cage, wherein the outer engagement features comprise protrusions configured to be inserted into and slide along the slots of the EDSFF cage.

12. A computing system, comprising:
a chassis comprising a base and a front panel;
a system board supported by the base;
an EDSFF drive cage disposed at or forming part of the front panel, the EDSFF drive cage comprising a plurality of EDSFF drive bays configured to receive EDSFF drives, each EDSFF drive bay comprising EDSFF-drive-bay engagement features configured to engage with complementary EDSFF-drive engagement features of the EDSFF drives;
an OCP backplane connected to the drive cage and comprising one or more OCP connectors positioned in at least a subset of bays of the plurality of bays;
one or more cables electrically connecting the OCP connectors to the system board;
an OCP module; and
an OCP adapter attached to the OCP module, wherein an assembly of the OCP adapter and the OCP module is received within a given bay of the subset of bays such that adapter engagement features of the OCP adapter engage with the EDSFF-drive-bay engagement features of the given bay to position the OCP module in an installed position in which the OCP module is connected to one of the OCP connectors.

13. The system of claim 12, wherein the OCP adapter comprises:
a frame defining an interior volume and comprising:
inner engagement features engaged with the OCP module received in the interior volume and to attach the OCP adapter to the OCP module;
outer engagement features configured to engage with the EDSFF-drive-bay engagement features as the OCP adapter is inserted into the given bay, the outer engagement features comprising the adapter engagement features; and
a latching mechanism connected to the frame and latched into a latching feature of the EDSFF cage.

14. The system of claim 13, wherein the OCP adapter further comprises an EMI shield extender comprising EMI springs, wherein the EMI shield extender is in contact with:
an EMI shield of the OCP module positioned above the EMI shield extender; and
a bottom EMI gasket of the EDSFF drive cage or a second EMI shield of an adjacent module positioned below the OCP adapter.

15. The system of claim 14, wherein the EMI shield extender is in contact with a top EMI gasket of the EDSFF or a third EMI shield extender of a second adjacent module positioned above the OCP adapter.

16. The system of claim 12, further comprising an EDSFF backplane connected to the EDSFF drive cage and comprising at least one EDSFF connector positioned in at least second subset of bays of the plurality of bays.

17. The system of claim 12, wherein the latching mechanism comprises a ridge snapped into a latching feature of the EDSFF drive cage.

18. The system of claim 12, wherein the latching mechanism comprises a groove snapped into a latching feature of the EDSFF drive cage.

19. A method comprising:
inserting an OCP module into an inner volume of an OCP adapter, wherein inserting the OCP module comprises engaging the OCP module with inner engagement features of the OCP adapter;
engaging outer engagement features of the OCP adapter with engagement features of a bay of an EDSFF drive cage;
moving the OCP adapter through the engagement features of EDSFF drive cage to an installed position; and
latching at least one latching mechanism of the OCP adapter to at least one latching feature of the EDSFF drive cage.

20. The method of claim 19, further comprising:
engaging an EMI shield extender of the OCP adapter with an EMI shield of the OCP module; and
engaging the EMI shield extender of the OCP adapter with one of: an EMI gasket of the EDSFF cage, or an EMI shield of an adjacent module.
